(19) United States
(12) Patent Application Publication
(10) Pub. No.: US 2012/0215575 A1
(43) Pub. Date: Aug. 23, 2012

(54) Risk Assessment And Prioritization Framework

(75) Inventors: Subhajit Deb, Gurgaon (IN); William Tyler Thornhill, Forney, TX (US); Gregory E. Williams, Irving, TX (US); Moriah Lazar Hara, New York, NY (US)

(73) Assignee: BANK OF AMERICA CORPORATION, Charlotte, NC (US)

(21) Appl. No.: 13/031,702

(22) Filed: Feb. 22, 2011

(51) Int. Cl. G06Q 10/00; G06Q 90/00

(52) U.S. Cl. 705/7.12; 705/500; 705/7.28

(57) ABSTRACT

A system and method of identifying, assessing and prioritizing risks are provided. The system and method may include a risk identification module that may identify one or more risks to a business, organization, entity, group or department within the entity, etc. One or more risk variables associated with each identified risk may then be identified. In some examples, the risk variables may be the same or substantially similar for all identified risks. A risk score for each identified risk variable may be determined and an overall risk score for each identified risk may then be determined based on the determined variable risk scores. In some examples, the overall score may be normalized on a predetermined scale. Once an overall score for each risk is determined, the risks having the highest priority may be identified.

### BACKGROUND

Today's business entities (including corporate, government, and the like) are dealing with more threats than ever. For instance, business entities today are dealing with cyber threats and other threats to electronic information, physical threats to workers, buildings, etc., chemical or biological threats from terrorists, and the like. Each of these categories of threats may include a variety of types of threats, severity of threats, etc. However, with the number of threats facing business entities today, it is difficult to identify risks and prioritize the use of resources to combat these risks. Accordingly, a system and method for objectively identifying and prioritizing risks would be advantageous.

### SUMMARY

The following presents a simplified summary in order to provide a basic understanding of some aspects of the present disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

According to one or more aspects, a system and method of identifying, assessing and prioritizing risks are provided. In some examples, the system and method may include a risk identification module that may identify one or more risks to a business, organization, entity, group or department within the entity, etc. One or more risk variables associated with each identified risk may then be identified. In some examples, the risk variables may be the same or substantially similar for all identified risks.

In some arrangements, a risk score for each identified risk variable may be determined. An overall risk score for each identified risk may then be determined based on the determined variable risk scores. In some examples, the overall score may be normalized on a predetermined scale. Once an overall score for each risk is determined, the risks having the highest priority may be identified. For instance, risks having the highest overall score may be identified as high priority risks. In some arrangements, resources such as funding, personnel, etc. may be allocated to the risks identified as priority risks based on the determined overall scores from the risk assessment and prioritization framework.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example system for identifying risks and a framework for prioritizing the identified risks according to one or more aspects described herein.

FIG. 3 illustrates one example method of identifying and prioritizing risks according to one or more aspects described herein.

FIG. 4 illustrates an example matrix for scoring risk variables and determining an overall risk score according to one or more aspects described herein.

FIG. 5 illustrates another example method for identifying and prioritizing risks according to one or more aspects described herein.

FIG. 6 illustrates one example graphical depiction of results of the risk assessment and prioritization framework according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

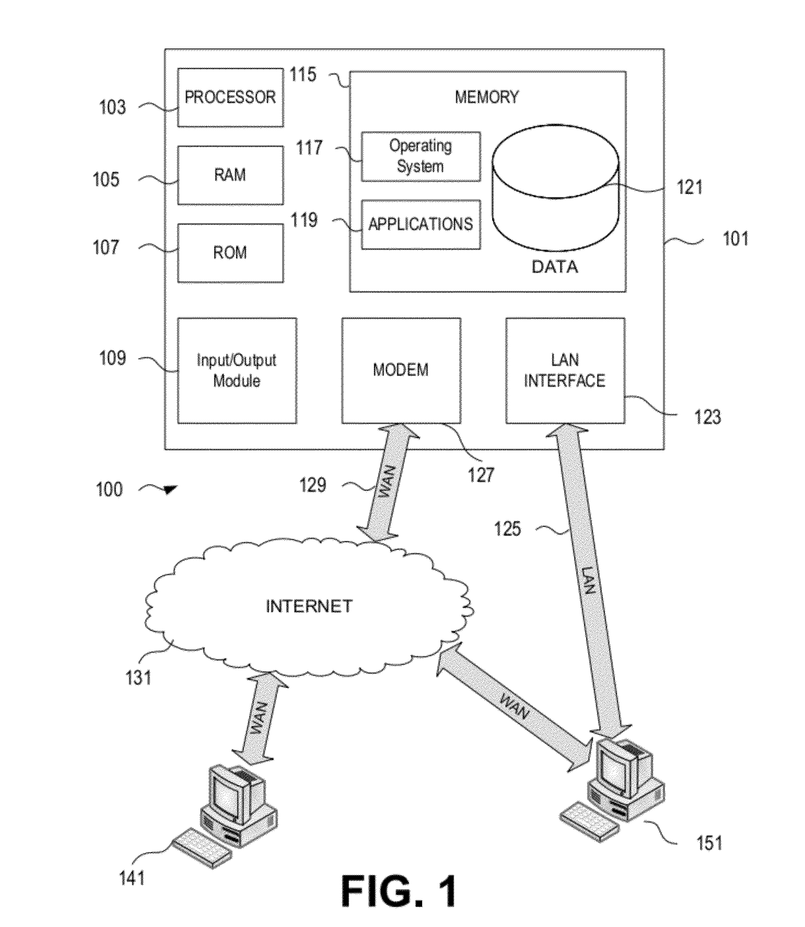

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that performs particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various businesses, companies, organizations, entities, etc. to provide a customizable framework for identifying risks and prioritizing those risks. In some arrangements, the framework may be provided to the businesses, companies, organizations, etc. via the Internet. Additionally or alternatively, entities using the framework may access it via internal systems, such as an intranet. Further, the framework may be used by multiple groups, departments, etc. within a business, company, organization, entity, etc. in order to customize the framework to identify risks pertinent to that particular group or department.

In some examples, the system and method of risk assessment and prioritization described herein may include identifying one or more risks that may pose a threat to a business, government entity, company, organization, etc. As mentioned above, the risks may include a variety of threat types, including cyber threats, physical threats, etc. As also mentioned above, the risk assessment and prioritization framework may be used by multiple groups, departments, etc. within the entity. This may permit the various departments to identify risks particular to that group or department and score those risks accordingly. Further, the customization of the framework may permit one or more groups or departments to remove perceived risks if those risks are not applicable to that group or department. For instance, the identified risks to a first group, such as finance or accounting department, may be different from the identified risks to a second group, such as an information technology department. Alternatively, the identified risks may be the same for two groups but the variables associated with those risks, and/or the scores for those risks, may differ, as will be discussed more fully below.

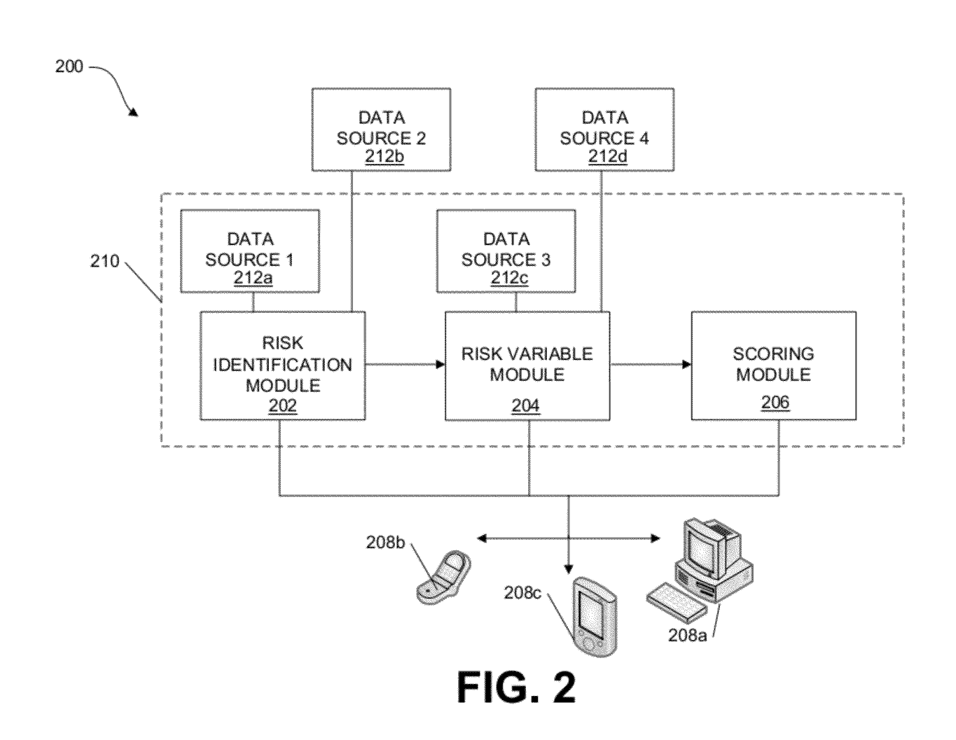

FIG. 2 illustrates one example system that may include a risk assessment and prioritization framework as described herein. The system 200 may be housed within a business, company, entity, etc, such as entity 210, or alternatively, may be external to the business or entity accessing the system (e.g., may be provided by an outside vendor or service provider). The system 200 may include a risk identification module 202. The risk identification module 202 may identify one or more risks that may pose a threat to the user of the system (e.g., the business, entity, group or department within the entity, etc.). The risks may be identified based on data stored within the entity, such as data source 1 212a, or data stored external to the entity, such as data source 2 212b. In some examples, the risks may also be provided to the risk identification module 202 by a user, such as via a computer terminal 208a, a cell phone or smart phone 208b and/or a personal digital assistant 208c. In some arrangements, the data stored may be compiled based on questionnaires or other surveys conducted with various groups, departments, personnel, etc. regarding perceived risks and variables associated therewith.

In some examples, the risk identification module 202 may identify appropriate risks for the user (e.g., department, group, entity, etc.) accessing the system 200. For instance, the identified risks may be customized to the particular user based on type of work, type of data used by the group (e.g., confidential, private, public, proprietary, etc.), nature of the business or unit (e.g., payment related processes, transaction processes, etc), sensitivity of the information (e.g., customer data, shareholder data, intellectual property, etc.), nature of the systems used (e.g., desktop computers, laptop computers, servers, Internet/intranet access, etc.), and the like. Additional factors may be used to identify risks without departing from the invention.

Some example risks that may be identified by the risk identification module 202 may include cyber threats, such as data loss from dumpster diving, shoulder surfing, email data leakage, file transmission data leakage, smartphone image data leakage, P2P data leakage, or social spaces data leakage. Additional risks may include insider attacks such as control avoidance, phishing, social engineering, spam, stolen hardware, unauthorized access and/or logic bombs. Still other risks may include application attacks such as buffer overflow, injection attacks, cross-site request forgery, and the like. Still other risks may include infrastructure attacks such as malware, cryptanalysis, wireless access points, wiretapping, and the like. Additional or alternative risks may include third party attacks, such as hosted services security, and/or mobile platform attacks, such as spoofing and/or telephony/VoIP exploits, and the like. Other risks may include eCommerce frauds, such as ATM skimming and compromise of a point of sale system. Although several risks and risks types are identified herein, additional risks and risk types may be identified and used with the system, method and framework described herein without departing from the invention. For instance, although several risks described above are cyber risks, additional risk categories and risks, such as natural disasters (e.g., earthquake, flood, landslide, hurricane, tornado, etc.), environmental disasters (e.g., faulty material management, hazardous waste, etc.), terrorist attack/war (e.g., world war, civil war, etc.), criminal act (e.g., fraud, espionage, etc.), regulatory (e.g., litigation, lawsuits, fines, etc.), and the like may be identified, evaluated, etc. as part of the framework without departing from the invention.

The system 200 may also include a risk variable module 204. The risk variable module 204 may identify one or more variables associated with the risks identified by the risk identification module 202. For instance, the risk variable module 204 may include a commercial vulnerability scoring system that identifies one or more variables for each risk. For instance, variables such as threat level, including network level, local level or adjacent network level, access complexity, authentication (none, single instance of authentication, multiple instances of authentication, etc.), impact (loss of revenue due to business interruption, dollar value of lost assets, etc.), likelihood, control effectiveness and/or time to act. Although various variables have been described above, additional variables may be used with the system 200 and/or framework without departing from the invention.

In some examples, the variables may be the same or substantially the same for each identified risk. In other arrangements, the variables may differ depending on the identified risk. Similar to the risk identification module 202, the risk variable module 204 may obtain data from data sources within the entity 210, such as data source 3 212c or external to the entity 210, such as data source 4 212d. Additionally or alternatively, variable data may be provided by a user via user devices 208a-208c.

The system 200 may further include a scoring module 206. The scoring module 206 may receive the identified risks and associated variables and may assign a score to the variables and/or to the risk overall. For instance, in some arrangements, the scoring module may assign a score to the one or more variables associated with each risk. The scores may, in some examples, be weighted. Additionally or alternatively, the scores may be normalized to simplify comparison of the risks and aid in prioritizing risks. In some examples, the scores may be based on user input received from user devices 208a-208c. For instance, a user may provide input on impact of a risk, or various other factors associated with one or more variable, to aid in determining a score for the variable and the risk.

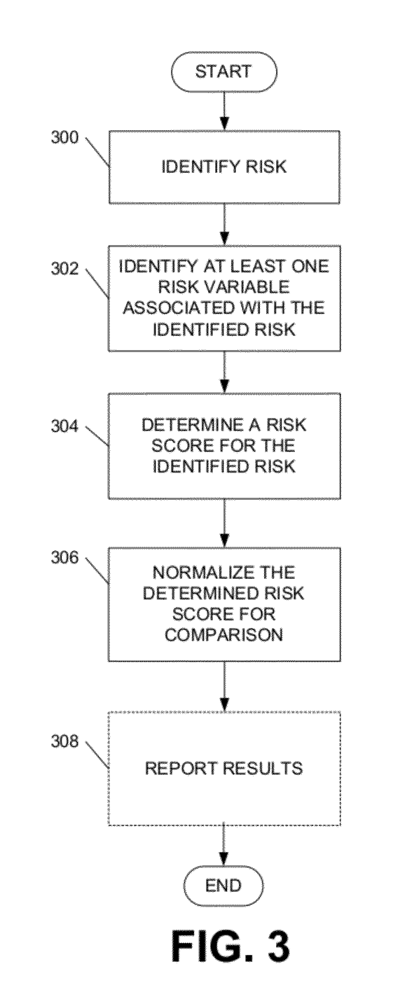

FIG. 3 is an example method of identifying risks using the risk assessment and prioritization framework as described herein. In step 300, a risk is identified. The risk may be identified by a risk identification module (such as module 202 in FIG. 2) as discussed above. The risks may include cyber risks, physical risks, and the like, as discussed above. In step 302, at least one risk variable associated with the identified risk may be identified. In some examples, the identified risk and risk variable may be stored in a matrix or framework, as will be discussed more fully below. In step 304, a risk score for the identified risk is determined. In some examples, the risk score may be based on a score determined for the identified risk variable. In some arrangements, a weighting or other factor may be included in determining the score. In step 306, the determined score may be normalized for ease of comparison. For instance, the score may be normalized to ease comparison for scores of other identified risks. For instance, the determined score may be normalized on a scale of 1 to 100. In optional step 308, the results may be reported. For instance, the score of the identified risk may be reported to a user. Additionally or alternatively, the score may be presented in a matrix, in a visual display such as a graph or chart, or via another report mechanism.

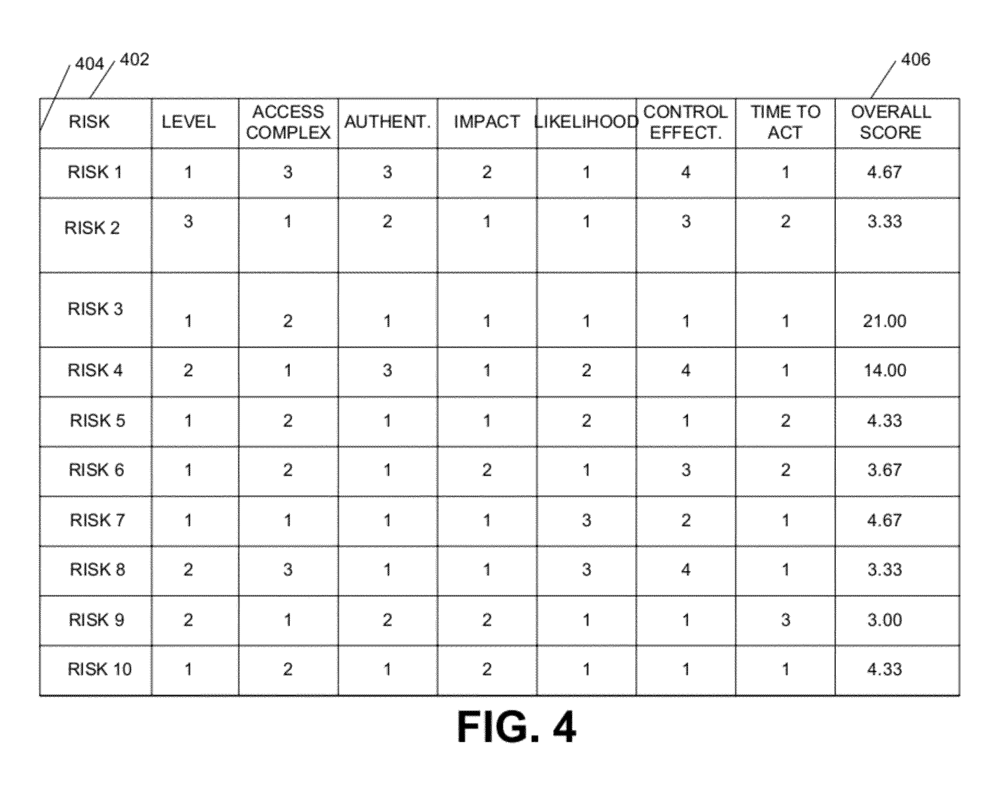

FIG. 4 illustrates one example matrix or framework that may be used with the risk assessment and prioritization system described herein. In a left column 402, the matrix may include one or more risks within a given category. Categories of risks may include, for example, cyber risks, political, geological, physical, and the like, may be included in the matrix or framework. The risks included in the example matrix of FIG. 4 are identified generically but may include risks such as data loss, including, for example, dumpster diving and/or email data leakage. Additional risks may include insider attacks such as stolen hardware and phishing, infrastructure attacks such as malware and/or wiretapping, mobile platform attacks such as spoofing and eCommerce fraud such as ATM skimming. These risks are just some examples of risks that may be identified. Additional or fewer risks may also be identified and ranked without departing from the invention.

Various risk variables are identified in a top row 404. The variables may include the level at which the risk is a threat (e.g., network, local, etc.), access complexity, authentication, impact, likelihood, control effectiveness and time to act. Fewer or additional variables may be included without departing from the invention. Each risk is associated with a score for each variable associated therewith. In some examples, a weighting scale or other scale (not shown) may be included with one or more variables. For instance, in some arrangements, each of 1) level at which threat is a risk, 2) access complexity, and 3) authentication, may be one third of an overall commercial vulnerability scoring system (CVSS) score as shown in rightmost column 406. Accordingly, each score determined for each of those variables may, in this example, be multiplied by 0.333 and then the result added to the result of the other adjusted variable scores to determine the CVSS score.

It should be noted that the values shown in the example matrix in FIG. 4 are simply example values and do not necessarily represent actual scores for the variables or the overall score. The scores are simply provided for illustrative purposes.

In another example, an overall risk appetite score may be determined by multiplying the impact score by the likelihood score. The various scores may be combined (such as by adding the variable scores, by adding the weighted variable scores, etc.) to determine an overall risk score (such as scores in column 406). This score may, in some examples, be normalized to a particular scale, as desired. For instance, several variables may be scored on a scale such as 1-3, 1-5, 1-10, etc. In order to compare the variables having differing scoring scales, the overall score may be normalized to a scale of, for instance, 1-100, such that each risk may be compared and the highest scoring risks may be identified as a priority for taking action, allocating resources, etc.

In some examples, a user may input, into the matrix, a term or predefined phrase for scoring a variable, which may then be converted to a numeric score. For instance, a user may determine that a likelihood of a threat is low, medium or high, and that term or phrase may be input into the matrix. The risk assessment and prioritization framework may then convert that term or phrase to a numeric score of, for instance, 1 for a low threat, 2 for a medium threat or 3 for a high threat.

Although the examples used herein illustrate higher numbers indicating a higher risk, the opposite scale may be used in which lower values would indicate a higher risk, without departing from the invention.

In some arrangements, the scores, such as the overall determined scores for a risk, normalized score for a risk, etc. may be color coded within the matrix to easily identify risks within or above a certain predefined threshold. For instance, the highest risks (those over a predetermined threshold) may be colored red to indicate importance. In some examples, this red color may be applied to any overall score or normalized score over, for example, 75, 80, 85 or 90. Risks having low scores, such as those below a predetermined threshold, may be colored green to indicate less importance. For example, scores below 25, 20, 15 or 10 may be colored green. Scores outside of these categories may be another color or may have additional thresholds and colors associated with those thresholds, as desired.

For example, in the example matrix of FIG. 4, Risk 3 and Risk 4 would be identified as priority risks if the prioritization was based on relative scores. Also, if the threshold specifies that scores greater than 10 are identified as high priority risks, these two risks would also be identified. The risks may then automatically be color coded red, or another color, to easily identify those risks as the high priority risks.

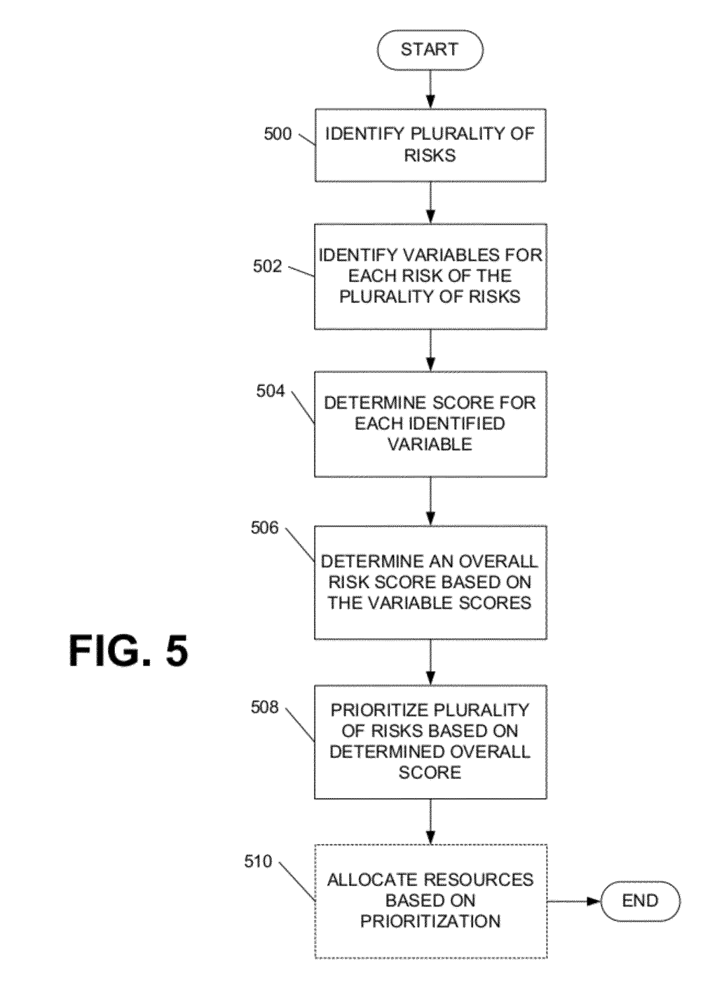

FIG. 5 illustrates another example method of risk assessment and prioritization according to aspects described herein. In step 500, a plurality of risks is identified. As discussed above, the risks may be identified based on the business type of the user, desires of the user, work environment of the user, etc. In step 502, risk variables for each type of risk are identified. In some examples, the risk variables may be the same or substantially similar for each identified risk. Alternatively, the risk variables may vary based on the identified risk. In step 504, a score for each identified risk variable is identified. An overall score is then determined in step 506. The overall score may be based on the determined variable scores and may include one or more weighting factors, etc., as discussed above.

In step 508, the overall scores for the identified risks may be evaluated and high priority risks may be determined. For instance, the risks having scores above a predefined threshold score may be identified as high priority risks. Additionally or alternatively, the high priority risks may be determined based on relative scores of the risks (e.g., the threshold may be adaptively determined based on the currently determined or available risk scores). For instance, the risks having the 3, 5, 10, etc. highest scores may be identified as priority risks. In optional step 510, various resources may be allocated based on the identified priority risks. For instance, additional funding may be provided to groups working to thwart those risks, additional personnel may be assigned to groups working to thwart those risks, etc.

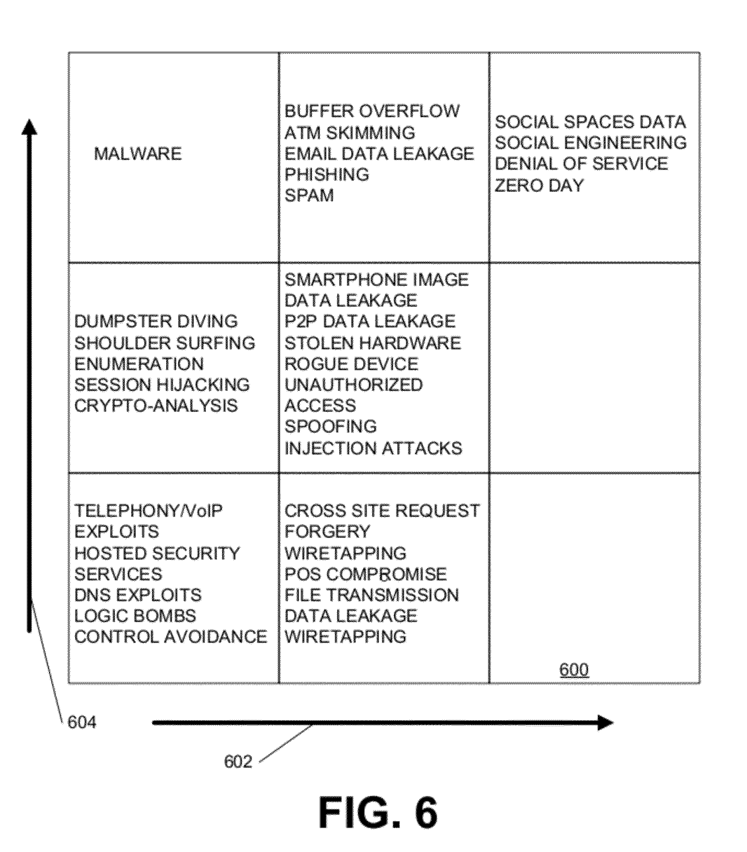

In some examples, the risks may be plotted, based on the determined scores, to visually illustrate the risks in order to identify those having high priority. FIG. 6 illustrates one example chart or matrix 600 that may aid in prioritizing risks. For instance, in the example chart 600 of FIG. 6, impact of risks may be indicated along the x-axis 602, while probability of the risks may be shown along the y-axis 604. In some examples, impact may be determined by multiplying the CVSS score by the risk appetite score. In other examples, the probability may be determined by multiplying a threat complexity or control effectiveness score by the velocity or time to act score. These values may be identified as “high,” “medium” or “low” based on the defined thresholds and may be mapped onto the axes. Accordingly, in one example, as you move to the right along the x-axis 602 of the matrix 600 in FIG. 6, each block represents an increase in impact. Further, as you move upward along the y-axis 604, each block represents an increase in probability. Thus, those risks having a high impact (e.g., on the right) and high probability (e.g., on the top) may likely be highest priority risks. Further, risks having high impact and medium probability may also be considered priority risks. The matrix of FIG. 6 is merely one example of graphically displaying the results of the risk assessment system. Additional arrangements, representations, etc. may be used with the determined scores without departing from the invention.

The risk assessment and prioritization framework described herein provides an objective and customizable approach to risk assessment and prioritization. Normalization of scores provides for a single scale on which all identified risks can be scored and compared. In addition, risks can be added and removed as desired by the user, group, department, business entity, etc. implementing the framework. Accordingly, the framework can be customized to the needs and/or desires of the user and can continue to be used as new threats or risks are identified and can be added to the framework.

The methods and features recited herein may further be implemented through any number of non-transitory computer readable media that are able to store computer readable instructions. Examples of non-transitory computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the disclosure is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present disclosure. The description is thus to be regarded as illustrative instead of restrictive on the present disclosure.

What is claimed is:

1. A method, comprising:
Identifying, by a risk assessment and prioritization system, a first risk;
Identifying, by the risk assessment and prioritization system, a plurality of risk variables associated with the first risk;
determining a score associated with each of the plurality of risk variables associated with the first potential risk; and
determining an overall risk threat score for the first risk based on the determined score associated with each of the plurality of risk variables associated with the first potential risk.

2. The method of claim 1, further including:
identifying, by the risk assessment and prioritization system, a second risk;
identifying, by the risk assessment and prioritization system, a plurality of risk variables associated with the second risk;
determining a score associated with each of the plurality of risk variables associated with the second risk; and
determining an overall risk threat score for the second risk based on the determined score associated with each of the plurality of risk variables associated with the second potential risk.

3. The method of claim 2, wherein the plurality of risk variables associated with the first risk are the same as the plurality of risk variables associated with the second risk.

4. The method of claim 2, further including normalizing the overall risk threat score for the first risk and second risk based on a pre-determined scale.

5. The method of claim 4, further including displaying the normalized overall risk threat score for the first risk and the second risk graphically.

6. The method of claim 4, further including prioritizing a risk for which action will be taken first based on the normalized scores of the first risk and the second risk.

7. The method of claim 1, wherein determining the score associated with each of the plurality of risk variables associated with the first risk includes receiving user input identifying a score for at least one of the risk variables.

8. The method of claim 1, wherein the plurality of risk variables includes at least one of: access, authentication, impact, likelihood, control effectiveness and time to act.

9. A method, comprising:
identifying, by a risk assessment and prioritization system, a plurality of risks;
identifying, by the risk assessment and prioritization system, a plurality of risk variables associated with each risk of the plurality of risks;
determining a score associated with each of the plurality of risk variables associated with each risk of the plurality of risks;
determining an overall risk threat score for each risk of the plurality of risks based on the determined score associated with each of the plurality of risk variables; and
identifying risks having an overall risk threat score above a predetermined threshold.

10. The method of claim 9, further including normalizing the overall risk threat score for each risk based on a predetermined scale.

11. The method of claim 9, wherein the risks identified as having an overall risk threat score above the predetermined threshold include a visual identifier.

12. The method of claim 11, wherein the visual identifier includes a color identifier.

13. The method of claim 9, further including allocating resources to alleviate the risks identified as being above the predetermined threshold.

14. One or more non-transitory computer readable media storing computer readable instructions that, when executed, cause a risk assessment and prioritization system to:
identify, by the risk assessment and prioritization system, a plurality of risks;
identify, by the risk assessment and prioritization system, a plurality of risk variables associated with each risk of the plurality of risks;
determine a score associated with each of the plurality of risk variables associated with each risk of the plurality of risks;
determine an overall risk threat score for each risk of the plurality of risks based on the determined score associated with each of the plurality of risk variables; and
identify risks having an overall risk threat score above a predetermined threshold.

15. The one or more non-transitory computer readable media of claim 14, wherein the instructions, when executed, further cause the risk assessment and prioritization system to normalize the overall risk threat score for each risk based on a predetermined scale.

16. The one or more non-transitory computer readable media of claim 14, wherein the risks identified as having an overall risk threat score above the predetermined threshold include a visual identifier.

17. The one or more non-transitory computer readable media of claim 16, wherein the visual identifier includes a color identifier.

18. The one or more non-transitory computer readable media of claim 14, wherein the instructions, when executed, further cause the risk assessment and prioritization system to allocate resources to alleviate the risks identified as being above the predetermined threshold.

19. An apparatus, comprising:
at least one processor; and
memory operatively coupled to the processor and storing computer readable instructions that, when executed, cause the apparatus to:
identify, by a risk assessment and prioritization system, a plurality of risks;
identify, by the risk assessment and prioritization system, a plurality of risk variables associated with each risk of the plurality of risks;
determine a score associated with each of the plurality of risk variables associated with each risk of the plurality of risks;
determine an overall risk threat score for each risk of the plurality of risks based on the determined score associated with each of the plurality of risk variables; and
identify risks having an overall risk threat score above a predetermined threshold.

20. The apparatus of claim 19, wherein the instructions, when executed, further cause the apparatus to normalize the overall risk threat score for each risk based on a predetermined scale.

21. The apparatus of claim 19, wherein the risks identified as having an overall risk threat score above the predetermined threshold include a visual identifier.

22. The apparatus of claim 21, wherein the visual identifier includes a color identifier.
